(19) United States
(12) Patent Application Publication
(10) Pub. No.: US 2010/0029490 A1
(43) Pub. Date: Feb. 4, 2010

(54) INK-JET DEVICE AND METHOD FOR PRODUCING A BIOLOGICAL ASSAY SUBSTRATE USING A PRINTING HEAD AND MEANS FOR ACCELERATED MOTION

(75) Inventors: Anke Pierik, Eindhoven (NL); Johan Frederik Dijksman, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,572

(22) PCT Filed: Sep. 17, 2007
(86) PCT No.: PCT/IB07/53741

§ 371 Date: Mar. 17, 2009

(30) Foreign Application Priority Data
Sep. 21, 2006 (EP) 06121021.7

(51) Int. Cl. C40B 30/00; B41J 2/01; B05D 3/12; B05D 5/00

(52) U.S. Cl. 506/7; 347/104; 427/240; 427/256

(57) ABSTRACT

The invention provides an ink jet device for producing a biological assay substrate. The device releases a plurality of substances onto the substrate from print heads, provided with the substances. The device further comprises means to subject the printed substrates to an accelerated motion. The accelerated motion which acts about perpendicular to the surface of the substrates acts to control penetration of the substances into the substrate. The invention also relates to a method for producing a biological assay substrate, and to a biological assay substrate obtainable by such method.

### FIELD OF THE INVENTION

The present invention relates to an ink jet device for producing a biological assay substrate by depositing a plurality of substances onto the substrate. The present invention further relates to a method for producing such biological assay substrate and to the use of an ink jet device thereto.

### BACKGROUND OF THE INVENTION

The present invention discloses an ink jet device for producing a biological assay substrate by depositing a plurality of substances onto a substrate, a method for producing such substrate, and the use of an ink jet device thereto. Especially for diagnostics, substrates are needed where a plurality of preferably different substances are positioned in a very precise and accurate manner. This plurality of substances are usually to be positioned on a substrate in order to perform a multitude of biochemical tests or reactions on the substrate.

Arrays of biological active materials on a substrate are used in biological test assays, for instance for the analysis of human blood or tissue samples for the presence of certain bacteria, viruses and/or fungi. The arrays consist of capture probe spots with a selective binding capacity for a predetermined indicative factor, such as a protein, DNA or RNA sequence that belongs to a specific bacterium, virus or fungus. By having capture probe spots with different specificity for different factors, the array may be used to assay for various different factors at the same time. The presence of an indicative factor may be visualized for instance by fluorescent labelling the molecules of the predetermined indicative factor, such as a protein, DNA or RNA sequence that belongs to a specific bacterium, virus or fungus contained in the tested sample, which results in a detectable fluorescence on the spot the specific factor adheres to. Using such arrays enables high-throughput screening of samples for a large amount of factors indicative of certain bacteria, viruses and/or fungi in a single run.

The capture probe spots are printed onto a substrate such as a membrane. In order to make the capture probes printable they preferably are dissolved in a solvent like water or alcohol. A suitable biological active material may for instance be a solution of a specific DNA sequence and/or antibody. The diagnostics of infectious diseases demands for a very high reliability of the overall process of making the substrate provided with the different capture probe spots, and more specifically the printing process of the capture probe spots. The read-out of the assay substrate for instance relates diseases directly to the positions of the specific capture probes. It is therefore important to be able to position the capture probes on the membrane reliably and correctly. It would further be highly desirable to be able to print more capture probe spots (for instance up to 1000 or more) of more different bioactive materials (for instance up to 100 or more) than is presently possible with known printing devices. This would enhance screening throughput.

### SUMMARY OF THE INVENTION

It is an object of the present invention to provide an ink jet device and method for producing a biological assay substrate by depositing a plurality of substances onto the substrate, which device and method allow to produce the substrate in a reliable and more efficient manner.

The above objective is accomplished by an ink jet device for producing a biological assay substrate by depositing a plurality of substances onto a porous substrate, as described in claim 1, by a method for producing such assay substrate, and by the use of an ink jet device according to the present invention. The ink jet device according to the invention comprises at least a print head, and mounting means for print head and substrate, respectively, whereby the device further comprises means to subject the substrate to an accelerated motion. The substances to be printed are ejected from the print head or heads of the ink jet device and hit the surface of the substrate. The printed substance then at least partly penetrates into the substrate. When the substrate structure is isotropic, penetration proceeds in all directions, thereby enlarging the capture probe spot size. Lateral growth of the printed capture probe spots may end up in overlapping spots when the printed spot areal density is too high. With the use of an ink jet device according to the invention, the substrates are subjected to an accelerated motion. It has surprisingly been found that this technical measure effectively controls penetration of the substances into the substrates, and therefore also the spot size. Being able to control spot size in an effective manner also allows to increase the areal density of the printed capture probe spots onto the substrates. The ink jet device according to the invention is particularly useful for depositing solutions of bioactive and other materials onto a substrate, since solutions tend to penetrate readily into a substrate upon drying.

The ink jet device according to the invention can advantageously be used to print a plurality of substances onto a porous substrate in a controlled manner. In particular the size, as well as the lateral and thickness distribution of the printed substance spots on the porous substrate may be controlled. Printing technologies often make use of the suction force of porous substrates, such as biological assay membranes. The actual positioning of the capture molecules depends among others on the suction force (which is itself controlled by factors such as pore size, pore size distribution of the membrane, surface tension of the substance and the wetting properties of the porous substrate as well as viscosity of the substance) and the evaporation rate of the solvent in which the capture molecules are diluted for printing. The ink jet device according to the invention advantageously uses the time it usually takes to evaporate the solvent, in order to control diffusion of the substance into the porous substrate.

An additional advantage of the ink jet device of the invention is that it allows to control the uptake of substances, in particular bioactive materials with fluorescent labelled bio-active molecules like protein, DNA or RNA sequences, by substrates in a number of ways. Indeed, it is possible for instance to provide a substrate with a plurality of bioactive fluid capture probe spots, which are penetrated deeply into the substrate such that growth of the active region in the lateral direction is effectively limited or even prevented. On the other hand, it is also possible to produce a test assay substrate having capture probe spots with fluorescent labelled molecules as close as possible to the surface of the substrate or membrane. This increases out-coupling of light and therefore improves the quality of the diagnosis.

The ink jet device according to the invention advantageously enables to produce substrates having smaller lateral dimensions than would be obtained by using the known ink jet device commonly used, without compromising on the number of printed capture probe spots. Such a membrane preferably comprises a plurality of capture probe spots with reduced size and pitch between the spots. A further advantage of the invented ink jet device is that it requires less fluid to accurately position a number of capture probe spots onto a substrate in order to obtain a certain surface density.

According to a preferred embodiment of the ink jet device according to the invention, the means to subject the substrate to an accelerated motion comprise a centrifuge equipped with at least driving means for a rotating drum, and a support structure for the rotating drum. The driving means are able to set the rotating drum of the centrifuge in a rotational movement at adjustable speed with respect to its stationary support structure. By attaching a plurality of substrates to the rotating drum said substrates are thus subjected to a centripetal acceleration, the magnitude of which depends on the rotational speed of the drum and the distance from the axis of rotation. Due to said centripetal acceleration of the substrates, the substances printed on the substrates will be subjected to centrifugal forces and therefore will be forced to diffuse (or even more precisely convected) in the direction of these forces. In this manner, the way the substances actually diffuse into a substrate may effectively be controlled. For instance, by fixing the position of the substrates with respect to the axis of rotation, the direction of the centripetal acceleration, and therefore of the centrifugal forces, may be altered.

The ink jet device according to the invention may preferably be used to enhance the penetration of a substance, such as a bioactive fluid, in the thickness direction of a substrate, such as a membrane. In such a preferred embodiment the ink jet device according to the invention comprises mounting means for the substrates provided on the rotating drum. Said mounting means for the substrates enable to affix a plurality of substrates along the inner lining of the drum of the centrifuge. In such case, the centrifugal forces on the printed substances act about perpendicular to the substrate surfaces. With “about” perpendicular is meant any angle which does not deviate more than 15% from 90 degrees. By using centrifugal forces, practically any desired distribution of printed substances may be obtained in the substrates, without having to rely on special substrate designs and/or morphological structures. As an example, in order to obtain sufficient penetration of a substance in a substrate, said substrate is mounted such that the centrifugal forces on the substance act in the depth direction of the substrate, i.e. towards the rear surface of the substrate. In practice thereto, the substrate is mounted on the drum such that its rear surface faces away from the centre of rotation. To produce a printed substrate with a substantial amount of substance close to the front surface of the substrate, the substrate should be mounted such that the centrifugal forces on the substance act in a direction towards the front surface. In practice thereto, the substrate is mounted on the drum such that its front surface faces away from the centre of rotation. In the context of this application the front surface of the substrate is defined as the surface onto which the substance is printed.

In a preferred embodiment of the ink jet device according to the invention, the mounting means for the print head are provided on the generally stationary support structure of the rotating drum. An accurate positioning of the print heads with respect to the printable substrates is desirable. By rigidly fixing the print heads on the generally stationary support structure of the rotating drum, for instance through a support ring, alignment errors may be limited or even prevented. It is, however, also possible to provide mounting means for the print heads which form an integral part of the rotating drum of the centrifuge.

In yet another preferred embodiment of the ink jet device according to the invention, the support structure for the rotating drum is centrally arranged within the rotating drum. The print heads are in this embodiment typically arranged circumferentially on the centrally disposed support structure of the rotating drum, such that they may dispose of their substances in a substantially radial direction. This embodiment in particular provides for an accurate deposition of spots of substance onto the substrates. Moreover, when aligning the substrates in the circumferential direction of the drum with their front surfaces substantially facing towards the centrally disposed support structure, printed substrates are effectively produced with sufficient penetration of the substance into the substrate such that growth of the spots in the lateral direction is effectively limited or even prevented.

In another preferred embodiment of the ink jet device according to the invention, the mounting means for the substrates comprise rotational means able to align the substrates with respect to the centripetal force acting on it. With a device according to this preferred embodiment, the substrates may easily be aligned in the circumferential direction of the drum with their rear surfaces substantially facing towards the centrally disposed support structure, by turning the mounting means, provided with substrates, over an angle of about 180 degrees. In such case, printed substrates are effectively produced with substance as close as possible to the surface of the substrate, which improves the quality of the diagnosis. It is also possible to turn the mounting means over any intermediate angle between 0 and 360 degrees, such that substantially any diffusional anisotropy may be obtained.

In yet another preferred embodiment of the ink jet device according to the invention, the support structure for the print heads is concentrically arranged around the rotating drum. The print heads are then typically arranged in the circumferential direction of the support structure facing inwards, i.e. away from the angle of rotation of the drum. In this embodiment the substrates are typically arranged in the circumferential direction of the outer surface of the rotating drum, facing the concentrically disposed inner wall surface of the support structure. Again, as already described above for another preferred embodiment, when aligning the substrates in the circumferential direction of the drum with their front surfaces substantially facing towards the inner wall surface of the support structure, printed substrates are effectively produced with sufficient penetration of the substance into the substrate such that growth of the spots in the lateral direction is effectively limited or even prevented. By providing rotatable mounting means for the substrates these may easily be aligned in the circumferential direction of the drum with their rear surfaces substantially facing the concentrically disposed inner wall of the support structure. In such case, printed substrates are effectively produced with substance as close as possible to the surface of the substrate, which improves the quality of the diagnosis.

In order to further control diffusion of the printed material into the substrates, the ink jet device according to the invention is further provided with detection means for assessing the penetration profile of the substance into the substrate, and more in particular the depth of penetration of the substances over the thickness of the substrates. Monitoring of the penetration profile may be carried out by any method known in the art. Suitable methods include optical, ultrasonic, and electrical measuring methods. It is advantageous to include the measurement apparatus into a feedback loop, which enables to control the driving means of the centrifugal drum dependent on the measured penetration profile.

Preferably the ink jet device according to the invention further comprises means to measure and adjust the relative position of the mounting means of print head and substrate, respectively. Although the ink jet device according to the invention may be provided with a print head with one nozzle only, the ink jet device preferably comprises a plurality of single nozzle print heads and/or a multi nozzle print head and/or a plurality of multi nozzle print heads. Thereby, it is possible to eject a plurality of droplets out of one single print head at one time. This speeds up the printing process.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the spots or the droplets do not only lie on the surface, but also penetrate into the membrane. As extensively discussed above, the ink jet device according to the invention is able to produce spots with the desired lateral an depth dimensions by effectively controlling penetration of the spots or droplets in the substrate or membrane.

In still a further embodiment of the present invention, the substrate comprises a plurality of substrate areas, each substrate area preferably being a separate membrane held by a membrane holder. Thereby, a plurality of separate membranes may be produced simultaneously by the use of the inventive ink jet device.

Further preferably, the substrate comprises a plurality of substrate locations, the substrate locations being separated from each other by at least the average diameter of a droplet positioned at one of the substrate locations. Thereby, it is possible to precisely and independently locate different droplets of a substance at precise locations on the substrate. It is also possible and advantageous to place a plurality of droplets on one and the same substrate location.

The substance, comprising biologically active molecules, is preferably dissolved in a solution. This solution is typically a liquid, like water or different types of alcohol, such as glycerol, glycol, DMSO and may also contain small amounts of additives, for instance to adjust the surface tension and/or viscosity. Also boiling point may be important, the higher the boiling point the slower the evaporation. All these factors are preferably considered in order to optimise print characteristics, spot formation, shelf life of the bioactive fluids, and so on.

The present invention also relates to a method for producing a biological assay substrate, wherein a plurality of substances are released from a print head onto the substrate, and the substrate is subjected to an accelerated motion. The advantages of the method according to the invention have been described in detail in the context of the ink jet device, and will not be repeated here. Preferably, in the method according to the invention, the substrate is subjected to an accelerated motion in a direction about perpendicular to the plane of the substrate. Such method effectively controls diffusion of the printed substance in the thickness direction of the membrane. By controlling diffusion over the substrate thickness, lateral dimensions of the printed substance spots may also be controlled. This allows to produce a biological assay substrate accurately. Moreover the biological assay substrate thus produced may exhibit a larger capture probe spot areal density than known hitherto.

In the method according to the invention, the substrate is preferably subjected to an accelerated motion by positioning the substrate onto the rotating drum of a centrifuge and rotating the drum at high speed, which imparts a centripetal force onto the substrate. It has advantages to characterize the method by releasing the substances from the print head onto the substrate at low or zero speed of the rotating drum. This improves printing accuracy. According to a further preferred embodiment, the method according to the invention is characterized in that the substrate is mounted such that the centripetal force acts from the surface of the substrate opposite the printing surface to the printing surface. In another preferred embodiment the substrate is mounted such that the centripetal force acts from the printing surface of the substrate to the surface facing away from the printing surface. The depth of penetration of the substances over the thickness of the substrates is preferably measured before, during and/or after accelerated motion.

The present invention also includes the use of an inventive ink jet device according to the present invention, wherein the substance comprises a biochemical reactant and/or a nucleic acid, and/or an oligonucleotide, and/or a polypeptide and/or a protein, and/or a cell, and/or (parts of) RNA/PNA/LNA. By using the inventive ink jet device for such a purpose, it is possible to very accurately print a certain number of substances on a substrate with control over the lateral and thickness dimensions of the deposited substances.

The present invention also relates to an assay substrate comprising a plurality of substances for biological analysis, which substrate may be obtained by the ink jet device and method of the present invention.

These and other aspects of the present invention will be apparent from and elucidated with reference to the embodiment(s) described hereinafter, taken in conjunction with the accompanying drawings, which illustrate, by way of example, the principles of the invention. The description is given for the sake of example only, without limiting the scope of the invention. The reference figures quoted below refer to the attached drawings.

### BRIEF DESCRIPTION OF THE DRAWINGS

In the figures:

FIG. 1 illustrates schematically a top view of a biological test array obtainable by the ink jet device and method of the present invention;

FIG. 2 illustrates schematically a top view of an embodiment of the ink jet device according to the invention;

FIG. 3 illustrates schematically a side view of the embodiment of the ink jet device, shown in FIG. 2;

FIG. 4 illustrates schematically a side view of another embodiment of the ink jet device according to the invention;

FIG. 5 illustrates schematically a top view of still another embodiment of the ink jet device according to the invention; and

FIG. 6 illustrates schematically a top view of still another embodiment of the ink jet device according to the invention.

### DETAILED DESCRIPTION OF EMBODIMENTS

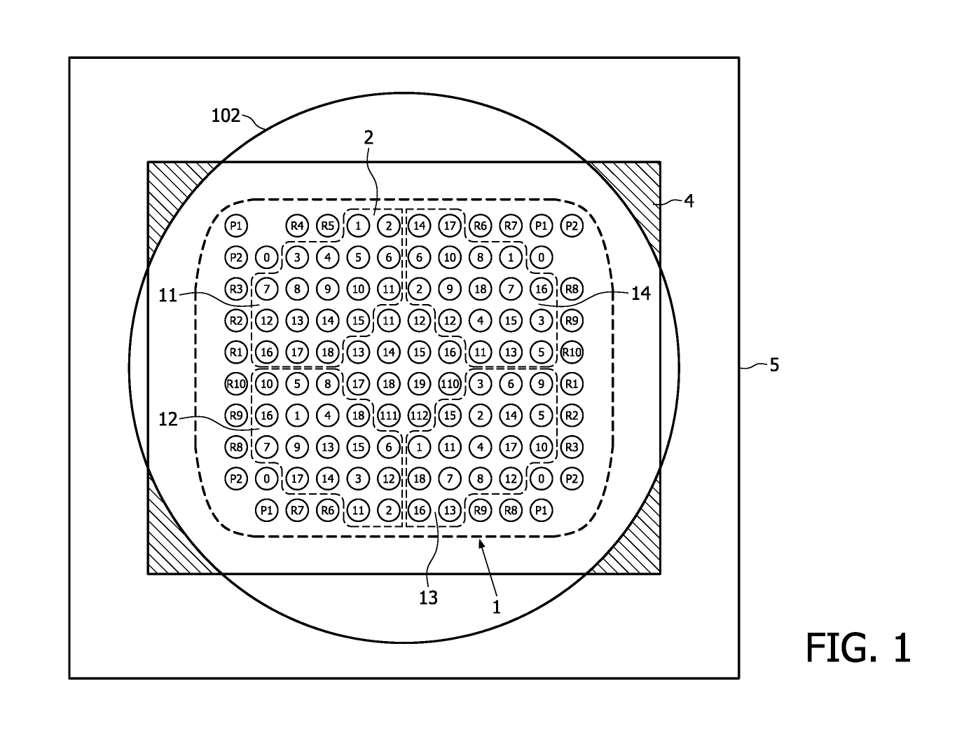

FIG. 1 shows a biological test array (1) obtainable by the ink jet device and method of the present invention, comprising spots (2) deposited on a circular membrane (102) of about 6 mm in diameter or preferably less than 6 mm. The test array (1) embodiment shown in FIG. 1 is covered with a pattern of 128 spots (2) comprising 43 different bioactive fluids, printed in a predefined pattern. The spots (2) are numbered, and each number represents a unique gene sequence or contains reference material. Note that the gene sequences occur in multiple duplicates in the array (1) on multiple mutually distant locations. The membrane (102) is fitted onto a supporting structure (not shown). As this is only an example, the number of spots may vary, and will usually be much larger, depending on the number of gene sequences and the number of duplicates used. The membrane (102) with the supporting structure (holder) is placed in a cartridge. In the cartridge the blood sample containing the different gene sequences characteristic for the DNA of different bacteria is brought into contact with the membrane (102) comprising the array of spots (2). Different DNA types (gene sequences) adhere to the different printed capture probe spots. In the embodiment shown in FIG. 1, different spots are visualised. The numbers 1 to 18 represent 9 different pathogens and 9 resistances. For reliability of the measurement, the same bio selective capture material is printed in four different quadrants (11, 12, 13, 14) of membrane (102). In each of the quadrants (11, 12, 13, 14), spots of the same number have different neighbouring spots, preventing that less intense spots (2) are not detected because of overexposure from adjacent spots (2). Intensity calibration spots (R1 to R10) may be printed on the membrane (102), as well as four spots (D) in the corners of the membrane for intensity calibration distribution over membrane (102). PCR control spots (P1, P2) are also printed to validate the proper DNA-amplification by means of PCR. A biological test array according to the invention preferably comprises a total amount of about 130 spots, as shown in FIG. 1, more preferably more than 400 spots, still more preferably more than 800 spots, most preferably more than 1000 spots. Typical diameters of the spots are lower than 200 μm, more preferably lower than 150 μm, still more preferably lower than 100 μm, and most preferably smaller than 50 μm and they are preferably positioned in a pattern with a pitch of less than 400 μm, more preferably less than 300 μm, still more preferably less than 200 μm, and most preferably less than 100 μm. Also a large amount of different bioactive fluids (preferably 100 or more) are typically printed on membrane (102).

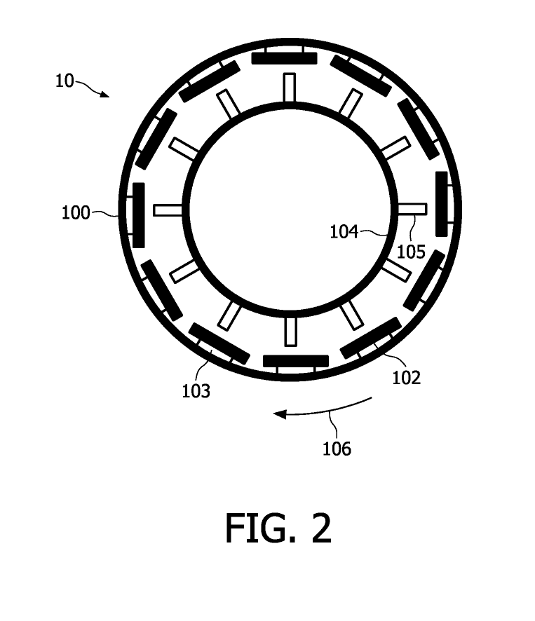

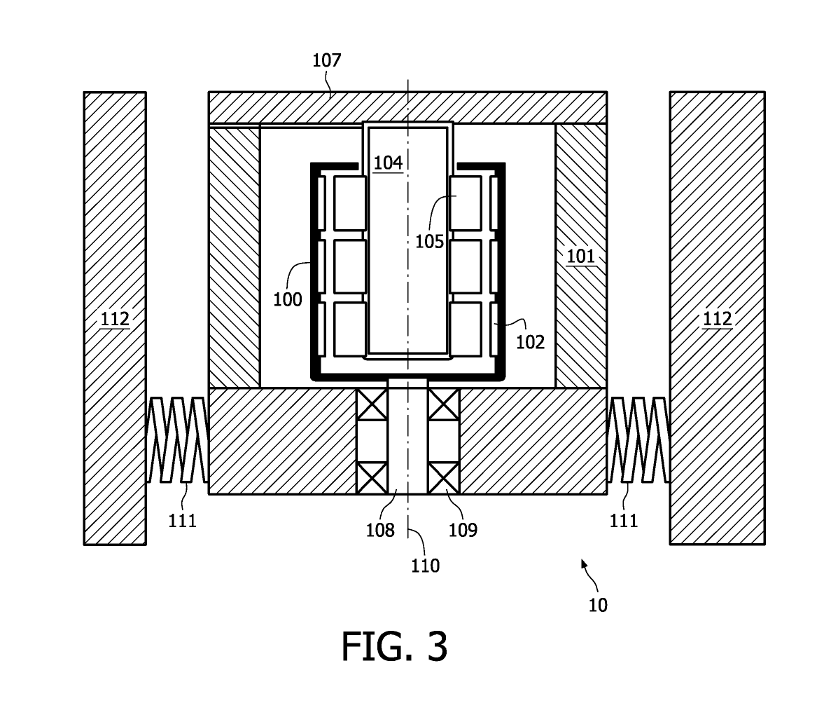

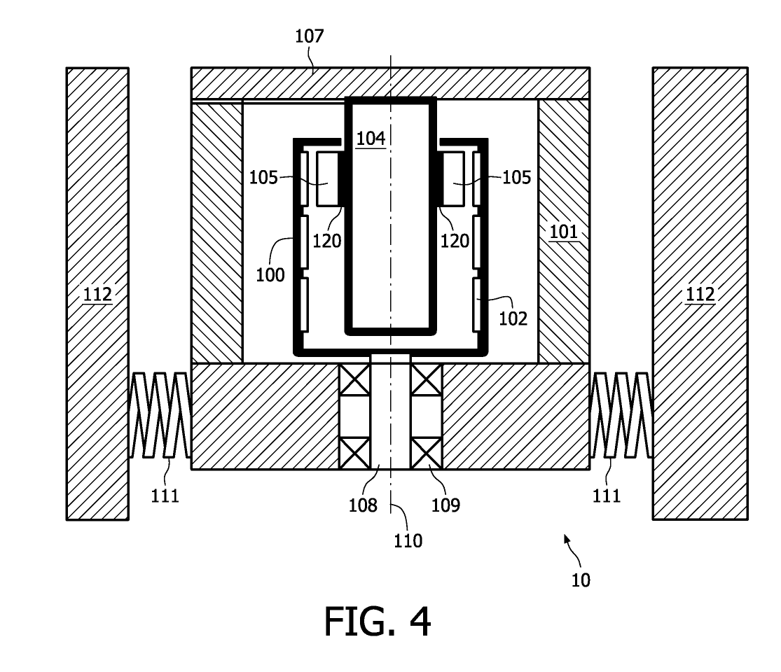

In FIG. 2, a schematic top view of the ink jet device (10) according to the present invention is shown, and more in particular a rotating drum (100) of a centrifuge, equipped with at least driving means (not shown) for the rotating drum (100), and a support structure (101) (see FIG. 3) for the rotating drum (100). A plurality of substrates or membranes (102) are mounted through suitable mounting means (103) onto the inner lining of the drum (100). On the centrally disposed support structure (101) is attached a stationary support ring (104) for a plurality of print heads (105). As schematically indicated in FIGS. 3 and 4, the stationary print head support ring is separately disposed from centrifuge drum (100). The driving means for the drum (100) enable to spin the drum around its central axis of rotation (110) (see FIG. 3). In FIG. 2, the rotational direction of the drum is indicated by arrow (106). In FIG. 3 a side view of the embodiment of the ink jet device, shown in FIG. 2 is illustrated. Apart from the components already described above, ink jet device (10) comprises a removable lid (107), which is attached to the support structure (101) of the drum (100) by bolts. The print head holder (104) is equipped with 3 sets of print heads (105), each set facing a corresponding ring of substrates or membranes (102). The drum (100) is supported by a centrally disposed shaft (108), guided by roller bearings (109) and rotationally driven by driving means. The stiff support structure (101) is suspended by a number of relatively weak springs (111) attached to earth through base structure (112). Due to the relatively weak suspension of the drum (100), the forces transferred to the environment are relatively low. Moreover, when turning the drum of the centrifuge will seek its own rotational axis, which may deviate from the axis of rotation (110) in rest. Among other factors, the distribution of mass along the inner circumference of the drum (100) and unbalances of the drum (100) and bearings (109) will have an influence on actual positioning. In the preferred embodiment shown in FIG. 3, the print head support ring (104) is rigidly fixed to the lid (107) of support structure (101). This ensures that the positioning of the print heads (105) with respect to the membranes (102) can be carried out without introducing substantial misalignment errors.

A preferred embodiment of the method for producing a biological assay substrate (1), wherein a plurality of substances are released from the print heads (105) onto a plurality of substrates (102) is as follows. In a first step the membranes (102) are securely positioned on rotating drum (100) and placed in the centrifuge support structure (101) through lid (107). The lid (107) is closed and the print heads (105) are positioned with respect to the membranes (102). In a second step the relative position of the membrane support drum (100) with respect to the stationary print head holder (104) in the rotational and height direction is determined and adjusted. In a third step substantially all printable membranes (102) are printed while the drum (100) rotates relatively slowly, usually a few turns per second. This step ensures that all print heads (105) provided with their respective fluids pass over all printable membranes (102), mounted onto drum (100). In a fourth step the drum (100) is accelerated to a high rotational speed, typically a few hundred turns per second. This rotational speed exerts a centripetal force onto the membranes (102), which causes the substances printed thereon to penetrate into the membranes (102), in the radially outward direction, facing away from the axis of rotation, i.e. towards the back surface of the membranes (102). When the desired depth of penetration has been reached the drum (100) is decelerated until full stop. In a final fifth step, the lid (107) is removed, the support drum (100) with the membranes (102) is taken out from the support structure (101), and finally replaced by another drum (100), provided with a set of unprinted substrates (102).

Another preferred embodiment of the ink jet device (10) according to the invention is shown in FIG. 4. In this embodiment the print heads (105) are mounted onto the print head holder (104) through slideable mounting means (120), which allow to move the print heads (105) up and down along the axis (110) of the centrifuge. In this way more membranes (102) can be provided with capture probe spots using fewer print heads (105).

The method for producing a biological assay substrate (1) is basically similar as described above. In case the time to print the membranes (102) is undesirably long, printing may be performed at relatively high rotational speed of the drum (100) as well. In this embodiment of the invented method, precautions have to be taken to ensure that the droplets land in the correct position on membranes (102). These precautions are known per se in the art and comprise for instance taking air forces in the gap between print head and substrate into account. To avoid the influence of the air forces on the droplets travelling from the print head towards the substrate the centrifuge can be evacuated prior to printing. This also speeds up the evaporation process and may result in shorter run times.

In order to improve accurate positioning of the substrates (102) on the drum (100), the ink jet printer (10) is preferably equipped with alignment cameras (not shown) that check the positions of all membranes (102) prior to printing. The actually measured positions are then preferably used by the printing software to deposit the droplets onto the membranes (102) at the correct positions.

In order to concentrate the printed substances such as bioactive material in the vicinity of one of the surfaces of a membrane (102), a preferred embodiment of the method according to the invention is as follows. In a first step the membranes (102) are securely positioned on rotating drum (100) and placed in the centrifuge support structure (101) through lid (107). The lid (107) is closed and the print heads (105) are positioned with respect to the membranes (102). In a second step the relative position of the membrane support drum (100) with respect to the stationary print head holder (104) in the rotational and height direction is determined and adjusted. In a third step substantially all printable membranes (102) are printed while the drum (100) rotates relatively slowly, usually a few turns per second. In a fourth step the drum (100) is accelerated to a high rotational speed, typically a few hundred turns per second. This rotational speed exerts a centripetal force onto the membranes (102), which causes the substances printed thereon to penetrate into the membranes (102), in the radially outward direction, facing away from the axis of rotation, i.e. towards the back surface of the membranes (102). Rotation of the drum (100) is maintained until substantially all substance material has been transported through membranes (102) and been collected at the rear surface of them. In general, the substance material is retained by the membrane because of surface tension. It may be necessary to treat the membrane at the rear surface in order to increase the surface tension there, and better retain the substance material. When the desired substance profile has been reached the drum (100) is decelerated until full stop. In a final fifth step, the lid (107) is removed, and the support drum (100) with the membranes (102) is taken out from the support structure (101).

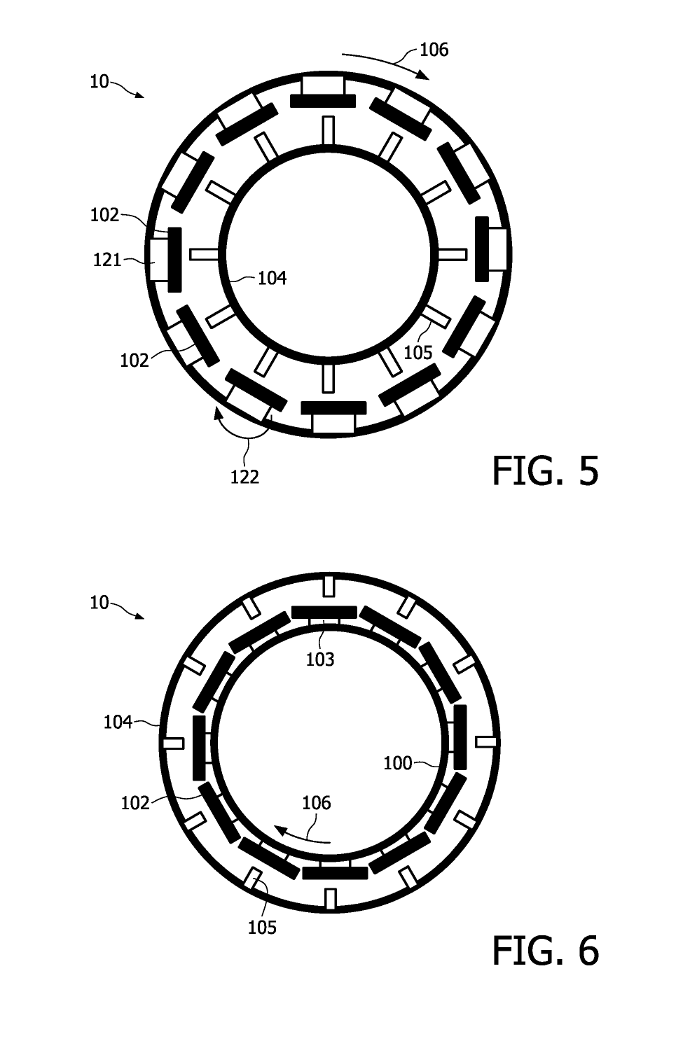

Another possibility is to mount the membranes (102) on mounting structures (121) that are rotatable around an axis (122) parallel to the centrifugal axis (110), as is shown in FIG. 5. This embodiment of the ink jet device allows to rotate the membranes (102) after they have been printed, for instance over an angle of 180 degrees. By rotating the drum (100) with the membranes (102) in such rotated position, the centrifugal action forces the substance material to flow to the front surface (the printing surface) of the membranes (102), where it is kept in place by surface tension. It may again be preferred to treat the front surface of the membranes (102), such that surface tension is increased.

A preferred embodiment of the method for producing a biological assay substrate (1), wherein a plurality of substances are released from the print heads (105) onto a plurality of substrates (102) is as follows. In a first step the membranes (102) are securely positioned on rotating drum (100) and placed in the centrifuge support structure (101) through lid (107). The lid (107) is closed and the print heads (105) are positioned with respect to the membranes (102). In a second step the relative position of the membrane support drum (100) with respect to the stationary print head holder (104) in the rotational and height direction is determined and adjusted. In a third step substantially all printable membranes (102) are printed while the drum (100) rotates relatively slowly, usually a few turns per second. This step ensures that all print heads (105) provided with their respective fluids pass over all printable membranes (102), mounted onto drum (100). In a fourth step the membranes (102) are rotated over about 180 degrees around their axes (122), i.e. parallel to the rotational axis (110) of the centrifuge. In a fifth step, the drum (100) is accelerated to a high rotational speed, typically a few hundred turns per second. This rotational speed exerts a centripetal force onto the membranes (102), which causes the substances printed thereon to penetrate into the membranes (102), in the radially outward direction, facing away from the axis of rotation, i.e. towards the front surface of the membranes (102). When the desired collection of substance at the front surface has been reached, the drum (100) is decelerated until full stop. In a final sixth step, the lid (107) is removed, the support drum (100) with the membranes (102) is taken out from the support structure (101), and finally replaced by another drum (100), provided with a set of unprinted substrates (102).

Finally, yet another embodiment of the ink jet device (10) is shown in FIG. 6. In this embodiment, the print heads (105) are mounted on an outer cylindrical and stationary support structure (104), while the substrates or membranes (102) are mounted through mounting means (103) on the outer lining of the rotating drum (100). Rotating drum (100) is in this embodiment placed inside the print head support structure (104). After membranes (102) have been printed as described above, the drum (100) is set in rotating motion which forces the printed substance material to collect at the front surface of the membranes (102), i.e. the surface facing the print heads (105).

While the present invention has been illustrated and described with respect to particular embodiments and with reference to certain drawings and foregoing description, such illustration and description are to be considered illustrative or exemplary and not restrictive. The invention is not limited to the described embodiments. Instead, the ink jet printer according to the present invention can be used for any precision placement of droplets onto membranes. It is particularly suited for the production of biosensors for molecular diagnostics. Diagnostics include rapid and sensitive detection of proteins and nucleic acids in complex biological mixtures, such as blood, urine, sperm or saliva, for on-site testing and for diagnostics in centralized laboratories. Other applications are in medical (DNA/protein diagnostics for cardiology, infectious disease and oncology), food, and environmental diagnostics.

In the drawings, the size of some of the elements may be exaggerated and not drawn to scale for illustrative purposes. Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

1. Ink jet device (10) for producing a biological assay substrate (102) by releasing a plurality of substances onto the substrate (102), the device (10) comprising at least a print head (105), and mounting means (104, 103) for print head (105) and substrate (102) respectively, whereby the device further comprises means to subject the substrate to an accelerated motion.

2. Ink jet device (10) according to claim 1, wherein the means to subject the substrate to an accelerated motion comprise a centrifuge equipped with at least driving means for a rotating drum (100), and a support structure (101) for the rotating drum (100).

3. Ink jet device (10) according to claim 1, wherein the mounting means (104) for the print heads (105) are stationary provided on the support structure (101) of the rotating drum.

4. Ink jet device (10) according to claim 1, wherein the mounting means (103) for the substrate (102) are provided on the rotating drum (100).

5. Ink jet device (10) according to claim 1, wherein the mounting means (104) for the print heads (105) are centrally arranged within the rotating drum (100).

6. Ink jet device (10) according to claim 1, wherein the mounting means (104) for the print heads (105) are concentrically arranged around the rotating drum (100).

7. Ink jet device (10) according to claim 1, wherein the mounting means for the substrates (102) comprise rotational means (121) able to align the substrates (102) with respect to the centripetal force acting on them.

8. Ink jet device (10) according to claim 1, wherein the device further comprises detection means for assessing the depth of penetration of the substances over the thickness of the substrates (102).

9. Ink jet device (10) according to claim 1, wherein the device further comprises means to measure and adjust the relative position of the mounting means (104, 103) of print head and substrate respectively.

10. Method for producing a biological assay substrate (102), wherein a plurality of substances are released from a print head (105) onto the substrate (102), and the substrate is subjected to an accelerated motion.

11. Method according to claim 10, wherein the substrate (102) is subjected to an accelerated motion in a direction about perpendicular to the plane of the substrate.

12. Method according to claim 10, wherein the substrate (102) is subjected to an accelerated motion by positioning the substrate onto the rotating drum (100) of a centrifuge and rotating the drum at high speed, which imparts a centripetal force onto the substrate (102).

13. Method according to claim 12, wherein the substances are released from the print head (105) onto the substrate (102) at low or zero speed of the rotating drum (100).

14. Method according to claim 10, wherein the substrate (102) is mounted such that the centripetal force acts from the side of the substrate opposite the printing to the printing surface.

15. Method according to claim 10, wherein the substrate (102) is mounted such that the centripetal force acts from the printing surface of the substrate to the surface opposite the printing surface.

16. Method according to claim 10, wherein the depth of penetration of the substances over the thickness of the substrates (102) is measured during accelerated motion.

17. Use of an ink jet device (10) according to claim 1, wherein the substance comprises a biochemical reactant and/or an oligonucleotide, and/or a polypeptide and/or a protein, and/or a cell, and/or (parts of) RNA/PNA/LNA.

18. Assay substrate comprising a plurality of substances for biological analysis, obtainable by the method according to claim 10.
